(19) United States
(12) Patent Application Publication
(10) Pub. No.: US 2015/0253351 A1
(43) Pub. Date: Sep. 10, 2015

(54) Detecting Imminent Use of a Device

(71) Applicant: QUALCOMM INCORPORATED, San Diego, CA (US)

(72) Inventors: Shankar SADASIVAM, San Diego, CA (US); Edward Harrison TEAGUE, San Diego, CA (US); Min-Yian SU, San Jose, CA (US)

(73) Assignee: QUALCOMM INCORPORATED, San Diego, CA (US)

(21) Appl. No.: 14/201,576

(22) Filed: Mar. 7, 2014

(51) Int. Cl. G01P 15/14; G06F 3/041; G01J 1/00

(52) U.S. Cl. CPC G01P 15/14; G01J 1/00; G06F 3/041; G06F 2203/04108

(57) ABSTRACT

Apparatuses and methods for detecting imminent use of a device are disclosed. According to aspects of the present disclosure, a device can be configured to consume sensor data, such as accelerometer data, or other available information obtained from low power sources. From the sensor data or other available information, the device is configured to determine an inference of imminent use. Based on the determination of inference of imminent use, the device can be configured to provide information for power management applications or situation aware applications in some implementations.

### FIELD

The present disclosure relates to the field of wireless communications, human-computer interaction and mobile user experience design. In particular, the present disclosure relates to apparatuses and methods of detecting imminent use of a device.

### BACKGROUND

Conventional mobile devices may not know whether it would be used or not in the near future until a user presses the “on/off” button or touches the screen. While in this uncertain state, conventional mobile devices may stay active or may become active periodically to perform a number of background tasks and data synchronizations in anticipation of the mobile device might be used. Such background tasks and data synchronizations may unnecessarily consume limited battery resources and/or consume communication bandwidth. Therefore, it would be beneficial to detect an inference of an imminent use of a device.

### SUMMARY

The present disclosure relates to apparatuses and methods for detecting imminent use of a device. According to aspects of the present disclosure, a device can be configured to consume sensor data, such as accelerometer data, or other available information obtained from low power sources. From the sensor data or other available information, the device can be configured to determine an inference of imminent use. Based on the inference of imminent use, the device can be configured to provide information for power management applications or situation aware applications, and/or other applications, according to some implementations of the disclosure.

In one embodiment, a method of detecting imminent use of a device may comprise receiving sensor data by one or more sensors of the device, and determining an inference of imminent use of the device based at least in part on the sensor data. The method of receiving sensor data may comprise receiving measurements collected by one or more accelerometers over a period of time in one or more axes, receiving measurements collected by one or more ambient light sensors over the period of time, receiving measurements collected by one or more proximity sensors over the period of time, and/or receiving measurements collected by one or more touch sensors over the period of time.

In one approach, the method of determining the inference of imminent use may comprise detecting one or more reference motions associated with the inference of imminent use, where one or more reference motions associated with the inference of imminent use comprise at least one of a first motion that indicates the device being picked up from a supporting surface, a second motion that indicates the device being pulled out of a holder, or a third motion that indicates the device being picked up from an idle state.

In another approach, the method of determining the inference of imminent use may comprise detecting one or more user-specific actions associated with the inference of imminent use, where the one or more user-specific actions associated with the inference of imminent use comprise at least one of a first action that indicates a user is left-handed, or a second action that indicates the user is right-handed.

In yet another approach, the method of determining the inference of imminent use may comprise detecting one or more contextual triggers associated with the inference of imminent use, where the one or more contextual triggers associated with the inference of imminent use comprise at least one of a first trigger that causes the device to vibrate, a second trigger that causes the device to ring, a third trigger that causes the device to flash a light emitting diode, or a fourth trigger that causes the device to generate an alert message.

In yet another approach, the method of determining the inference of imminent use may comprise collecting contextual data related to a history of use of the device, and determining the inference of imminent use based at least in part on the contextual data.

In another embodiment, a device may comprise one or more sensors configured to receive sensor data, a non-transitory memory configured to store the sensor data, and a controller including one or more processors and an imminent use detector, where the one or more processors and the imminent use detector comprise logic configured to determine an inference of imminent use of the device based at least in part on the sensor data.

In yet another embodiment, a computer program product may comprise non-transitory medium storing instructions for execution by one or more computer systems. The instructions may comprise instructions for receiving sensor data by one or more sensors of the device, and instructions for determining an inference of imminent use of the device based at least in part on the sensor data.

In yet another embodiment, an apparatus may comprise means for receiving sensor data, and means for determining an inference of imminent use of the device based at least in part on the sensor data.

### BRIEF DESCRIPTION OF THE DRAWINGS

The aforementioned features and advantages of the disclosure, as well as additional features and advantages thereof, will be more clearly understandable after reading detailed descriptions of embodiments of the disclosure in conjunction with the non-limiting and non-exhaustive aspects of following drawings. Like numbers are used throughout the figures.

FIG. 1 illustrates an exemplary flow chart of detecting imminent use of a device according to some aspects of the present disclosure.

FIG. 2A illustrates a group of exemplary sensor observations for pick-up detection of a mobile device according to some aspects of the present disclosure.

FIG. 2B illustrates another group of exemplary sensor observations for pick-up detection of a mobile device according to some aspects of the present disclosure.

FIG. 2C illustrates yet another group of exemplary sensor observations for pick-up detection of a mobile device according to some aspects of the present disclosure.

FIG. 2D illustrates yet another group of exemplary sensor observations for pick-up detection of a mobile device according to some aspects of the present disclosure.

FIG. 3 illustrates an exemplary method of detecting face position of a mobile device according to some aspects of the present disclosure.

FIG. 4A illustrates a group of exemplary sensor observations for stabilization detection of a mobile device according to some aspects of the present disclosure.

FIG. 4B illustrates another group of exemplary sensor observations for angle stabilization detection of a mobile device according to some aspects of the present disclosure.

FIG. 5A illustrates an exemplary embodiment of three axes angle stabilization of a mobile device according to some aspects of the present disclosure.

FIG. 5B illustrates another exemplary embodiment of three axes angle stabilization of a mobile device according to some aspects of the present disclosure.

FIG. 6 illustrates an exemplary block diagram of a mobile device according to some aspects of the present disclosure.

FIG. 7A illustrates an exemplary application environment of an imminent use detector according to some aspects of the present disclosure.

FIG. 7B illustrates another exemplary application environment of an imminent use detector according to some aspects of the present disclosure.

FIG. 7C illustrates an exemplary application upon a determination of an inference of imminent use of a device according to some aspects of the present disclosure.

FIG. 8A illustrates an exemplary flow chart of detecting imminent use of a device according to some aspects of the present disclosure.

FIG. 8B illustrates an exemplary implementation of receiving sensor data of FIG. 8A according to some aspects of the present disclosure.

FIG. 8C illustrates exemplary implementations of determining an inference of imminent use of the device of FIG. 8A according to some aspects of the present disclosure.

### DESCRIPTION OF EMBODIMENTS

Embodiments of detecting imminent use of a device are disclosed. The following descriptions are presented to enable any person skilled in the art to make and use the disclosure. Descriptions of specific embodiments and applications are provided only as examples. Various modifications and combinations of the examples described herein will be readily apparent to those skilled in the art, and the general principles defined herein may be applied to other examples and applications without departing from the scope of the disclosure. Thus, the present disclosure is not intended to be limited to the examples described and shown, but is to be accorded the scope consistent with the principles and features disclosed herein. The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

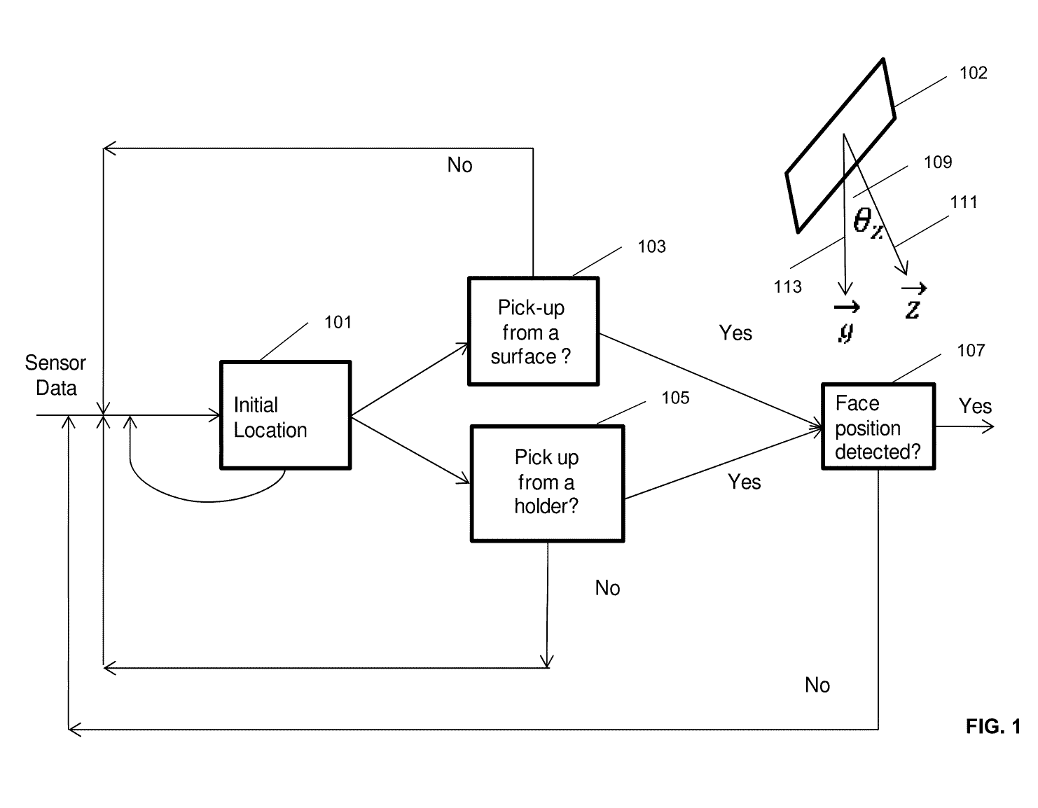

FIG. 1 illustrates an exemplary flow chart of detecting imminent use of a device according to some aspects of the present disclosure. In this example, the method of detecting imminent use of a device as performed by an imminent use detector may include the functions performed in blocks 101 to 107 of FIG. 1. In block 101, the method receives sensor data from one or more sensors. According to aspects of the present disclosure, the sensor data may be collected by one or more accelerometers, one or more proximity sensors, one or more ambient light sensors, or other types of sensors. Using the sensor data received, the method may determine an initial location of a mobile device 102. Examples of initial location of the mobile device 102 may be on a desk (face up or face down), in a pocket, in a bag, being held in a hand, or other possible initial locations. If the initial location of the mobile device 102 is on a desk, the method moves to block 103; and if the initial location of the mobile device 102 is in a pocket or bag, the method moves to block 105; and if the initial location of the mobile device 102 is neither on a desk nor in a pocket or a bag, the method stays in block 101.

Note that the paragraph above uses a desk as an example of indicating the initial location of the mobile device 102 being placed on a supporting surface, such as a desk. A person skilled in the art would understand that other types of supporting surfaces, such as a countertop, a floor, a bed, etc. may also be used as a supporting surface. Also note that the paragraph above uses a pocket or a bag to indicate an example of a holder of the mobile device 102. A person skilled in the art would understand that other types of holders, such as a backpack, a purse, a removable cover, etc. may also be used as a holder of the mobile device 102.

According to aspects of the present disclosure, one approach to determine whether the initial location of a mobile device 102 is on a desk and facing up is to examine the angle 109 between the accelerometer z-axis vector 111 and the gravity vector 113. The mobile device 102 may be considered to be placed on a desk (and face up) if the angle is smaller than a predetermined value (e.g. 5 degrees) for at least a predetermined period of time, such as at least 4 seconds. One approach to determine whether the initial location of a mobile device 102 is on a desk (and face down), in a pocket, or in a bag, is to examine the sensor data collected by one or more proximity sensors. The mobile device 102 may be considered to be on a desk (and face down), in a pocket, or in a bag if proximity has been detected for a predetermined period of time, for example for 4 seconds. In some implementations, accelerometer information may be used to disambiguate between whether the mobile device 102 may be placed face down on a desk, placed in a pocket, or placed in a bag. Using the accelerometer information, the angle 109 between the accelerometer z-axis vector 111 of the mobile device 102 and gravity vector 113 can be computed. This angle may be about 180 degrees (e.g. with a tolerance of 5 degrees or less) if the mobile device 102 is being placed face down on a desk. On the other hand, this angle may be fluctuating or may not meet the above condition if the mobile device 102 is being placed in a pocket or being placed in a bag.

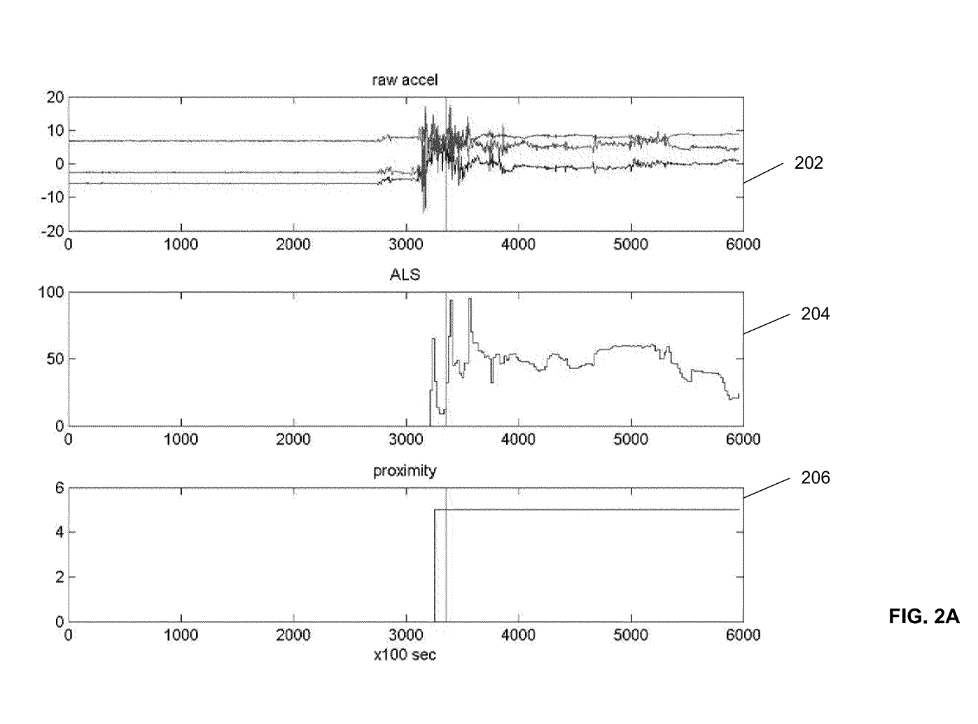

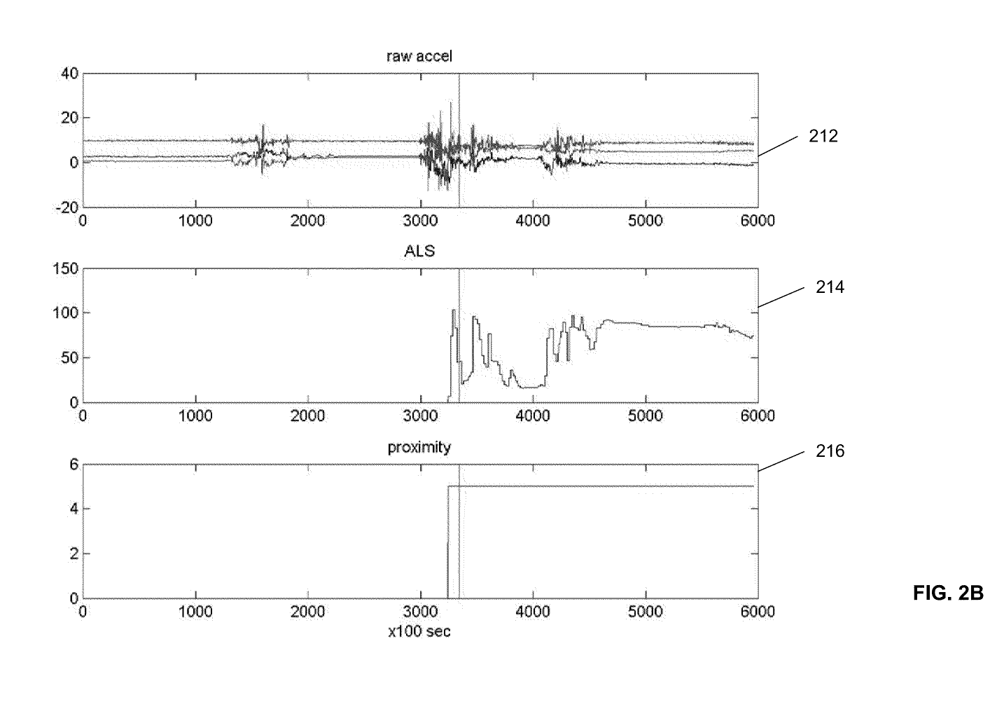

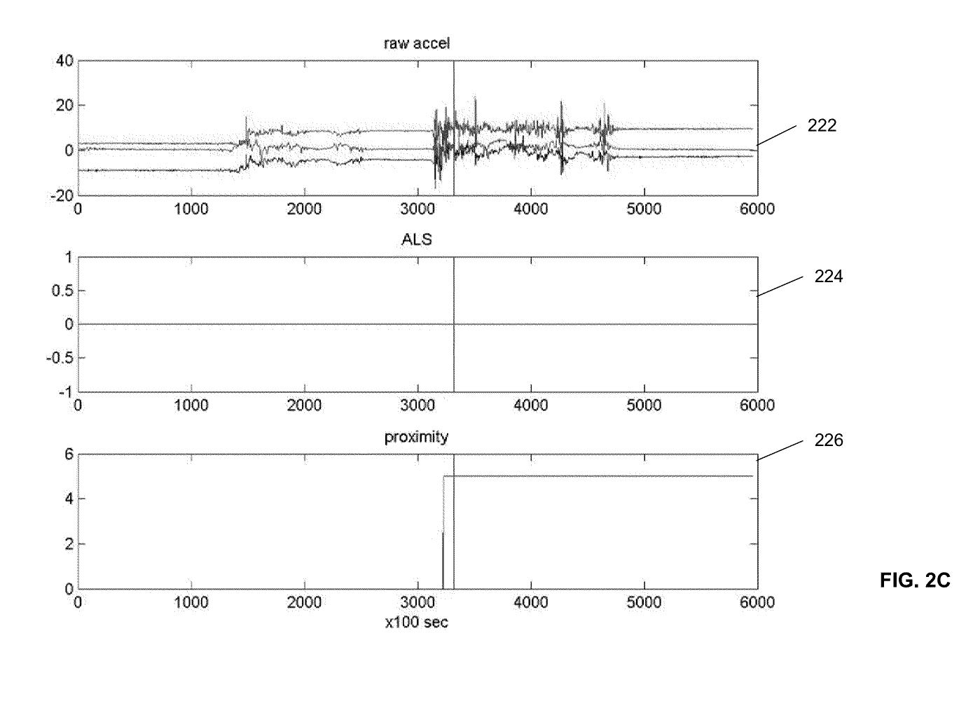

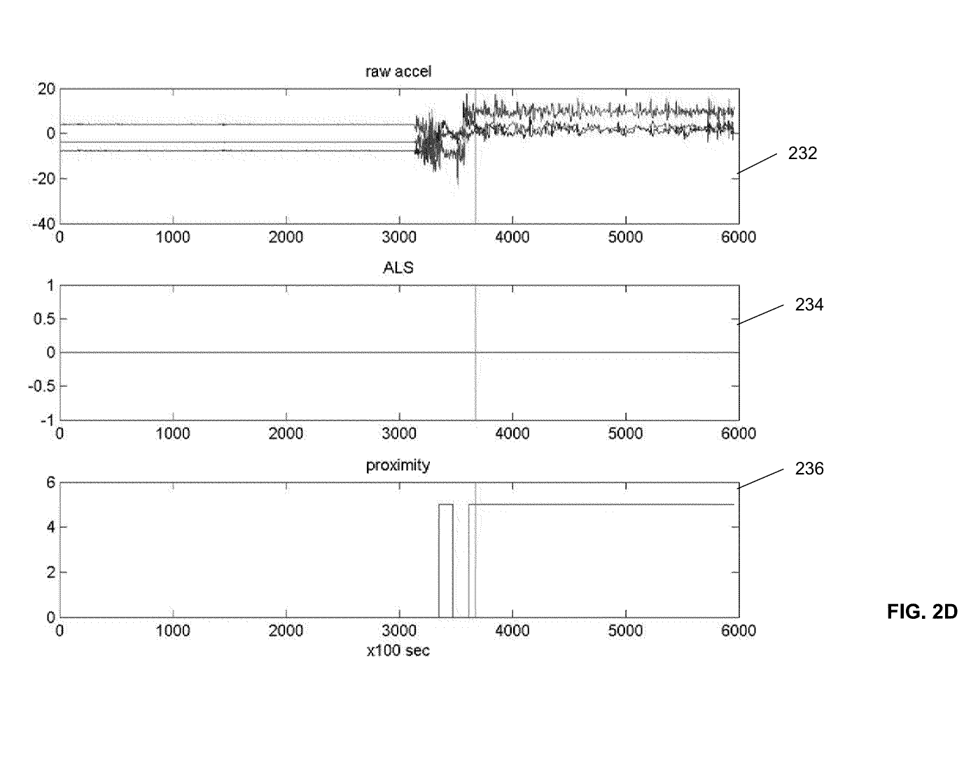

In block 103, the method may determine whether the mobile device 102 has been picked up from a supporting surface (e.g. a desk). In some implementations, the method of pick-up detection may take into consideration a combination of accelerometer and proximity sensor data to predict a pick-up action of the mobile device 102 using pre-trained statistical models. This approach is further described in the following sections in association with the description of FIG. 2A-2D. If the mobile device 102 has not been picked up from the supporting surface, the method returns to block 101. Alternatively, if the mobile device 102 has been picked up from the supporting surface, the method moves to block 107. In one exemplary implementation, if it is determined that the mobile device 102 has been picked up from the supporting surface, the method may begin to perform application synchronization. In another exemplary implementation, if it is determined that the mobile device 102 has been picked up from the supporting surface, the method may turn on the display automatically without having the user to touch the display or to press an on/off button of the mobile device 102.

In block 105, the method may determine whether the mobile device 102 has been picked up from a holder (such as a pocket or a bag). If the mobile device 102 has not been picked up from the holder, the method returns to block 101. Alternatively, if the mobile device 102 has been picked up from the holder, the method moves to block 107. Similarly, if it has been determined that the mobile device 102 has been picked up from the holder, the method may begin to perform application synchronization.

In block 107, the method may determine whether a face position of the mobile device 102 has been detected. According to aspects of the present disclosure, a face position refers to a position where a display of the mobile device 102 is being held facing to the user. The user may be in an upright position, such as in a sitting or standing position. If the face position of the mobile device 102 has not been detected, the method returns to block 101. Alternatively, if the face position of the mobile device 102 has been detected, the method may turn on the screen of the mobile device 102 automatically without user input. In addition, the mobile device 102 may be configured to display notifications, predicted applications to be used, and/or status information in response to a determination of an inference of imminent use. This feature can further enhance the user experience of the mobile device 102. In some implementations, the face position detection performed in block 107 may further comprise a detection of angle stabilization and face up angle estimation. The detection of angle stabilization and face up angle estimation are further described in the following sections.

According to aspects of the present disclosure, the imminent use detector may generate various outputs to be used by other applications and components of the mobile device 102. For example, in block 101, the imminent use detector may produce an output to indicate the current position of the mobile device 102, i.e., whether it is on a supporting surface (e.g. desk), in a holder (e.g. bag or pocket), being held in the hand of a user, or the location of the mobile device 102 may be unknown. In block 103 or block 105, the imminent use detector may produce an output to indicate whether the mobile device 102 has been picked up, has not been picked out, or it has not yet been determined (unknown). In block 107, the imminent use detector may produce an output to indicate whether the face position of the mobile device 102 has been detected, has not been detected, or it has not yet been determined (unknown).

According to aspects of the present disclosure, the pick-up detection performed in block 103 and block 105 of FIG. 1 may further comprise a detection of initial signal being triggered. In some implementations, the initial signal may be triggered when the mobile device 102 is detected to be moved from a static state position, for example being moved from a stationary position. In one approach, upon receiving sensor data from an accelerometer, a standard deviation of the accelerometer vector in a predetermined time window, for example within a range of 0.2 second, may be computed. Then, the standard deviation of the accelerometer vector may be compared to a predetermined threshold. If the standard deviation of the accelerometer vector exceeds the predetermined threshold, then the initial signal may be deemed to be triggered. Alternatively, if the standard deviation of the accelerometer vector does not exceed the predetermined threshold, then the initial signal may be deemed to be not triggered.

According to aspects of the present disclosure, a pick-up classification based on logistic regression of measured features may be configured to identify the validity of one or more pickup motions, and may further be configured to classify such pick-up motions. The features may include statistics of sensor data collected by the accelerometer within a time window, for example 0.15 second around the initial signal. According to aspects of the present disclosure, other window durations, such as 0.1 second, 0.3 second, 0.5 second, etc. may be used. In some exemplary implementations, various features may be selected to be observed, including but not limited to: 1) raw accelerometer vector over the time window; 2) adjusted accelerometer vector (defined as raw accelerometer vector minus the estimated gravity vector (relative to phone coordinates)); 3) standard deviation of the raw or adjusted accelerometer vector over the time window; 4) variance of the raw or adjusted accelerometer vector in an individual axis (e.g., x, y, or z axis) over the time window, 5) sum of variances of the raw or adjusted accelerometer vector in three axes (e.g., x, y, and z axes); 6) different time window durations; 7) different time window offsets with respect to the initial signal being triggered; 8) derivative of the raw or adjusted accelerometer vector prior to computing its variance over the time window; and/or 9) derivative of the raw or adjusted accelerometer vector prior to computing its standard deviation over the time window. According to aspects of the present disclosure, the above features may be used in combination for performing logistic regression to determine pick-up detection and pick-up classification.

The exemplary sensor observations as shown in association with FIG. 2A-2D further illustrate methods of detecting whether the initial signal has been triggered, whether a mobile device has been picked up, as well as determining an inference of imminent use of the mobile device. FIG. 2A illustrates a group of exemplary sensor observations for pick-up detection of a mobile device according to some aspects of the present disclosure. In the example shown in FIG. 2A, each unit of 100 represents 1 second in the horizontal axis of an observation window. At approximately after the 30 second point, a mobile device may be detected to be taken out from a jacket pocket, which may be represented by the path of block 101 and block 105 of FIG. 1. Window 202 may show exemplary measurements of one or more accelerometers over time; window 204 may show exemplary measurements of one or more ambient light sensors over time; and window 206 may show exemplary measurements of one or more proximity sensors over time. According to aspects of the present disclosure, using such observations from one or more of windows 202, 204, or 206, a mobile device can be configured to perform pick-up detection, and the results from the pick-up detection can be used to determine an inference of imminent use of the mobile device.

FIG. 2B illustrates another group of exemplary sensor observations for pick-up detection of a mobile device according to some aspects of the present disclosure. Similar to the figure shown in FIG. 2A, at approximately after the 30 second point, a mobile device may be detected to be taken out from a pant pocket, which may be represented by the path of block 101 and block 105 of FIG. 1. Window 212 may show exemplary measurements of one or more accelerometers over time; window 214 may show exemplary measurements of one or more ambient light sensors over time; and window 216 may show exemplary measurements of one or more proximity sensors over time. Each window 212 or 214 shows different sensor data characteristics than that of window 202 or 204. According to aspects of the present disclosure, using such observations from one or more of windows 212, 214, or 216, a mobile device can be configured to perform pick-up detection, and the results from the pick-up detection can be used to determine an inference of imminent use of the mobile device.

FIG. 2C illustrates yet another group of exemplary sensor observations for pick-up detection of a mobile device according to some aspects of the present disclosure. Similar to the figure shown in FIG. 2A, at approximately after the 30 second point, a mobile device may be detected to be taken out from a jacket pocket and with the one or more ambient light sensors being turned off. This action may be represented by the path of block 101 and block 105 of FIG. 1. Window 222 may show exemplary measurements of one or more accelerometers over time; window 224 may show no measurements by the one or more ambient light sensors; and window 226 may show exemplary measurements of one or more proximity sensors over time. The window 222 may show different sensor data characteristics than that of window 202. According to aspects of the present disclosure, using such observations from one or more of windows 222 and/or 226, a mobile device can be configured to perform pick-up detection, and the results from the pick-up detection can be used to determine an inference of imminent use of the mobile device.

FIG. 2D illustrates yet another group of exemplary sensor observations for pick-up detection of a mobile device according to some aspects of the present disclosure. Similar to the figure shown in FIG. 2A, at approximately after the 30 second point, a mobile device may be detected to be taken out from a backpack and with the one or more ambient light being sensors being turned off. This action may be represented by the path of block 101 and block 105 of FIG. 1. Window 232 may show exemplary measurements of one or more accelerometers over time; window 234 may show no measurements by the one or more ambient light sensors; and window 236 may show exemplary measurements of one or more proximity sensors over time. Each of the windows 232 or 236 may show different sensor data characteristics than that of window 202 or 206. According to aspects of the present disclosure, using such observations from one or more of windows 232 and/or 236, a mobile device can be configured to perform pick-up detection, and the results from the pick-up detection can be used to determine an inference of imminent use of the mobile device.

According to aspects of the present disclosure, logistic regression may be used to predict the outcome of an inference of imminent use of a device based on measurements obtained by one or more sensors (also referred to as predictor variables). For example, logistic regression may be used in estimating empirical values of the parameters in a qualitative statistical model. The possible outcomes of trials may be modeled, as a function of the measurements made by the one or more sensors. In addition, logistic regression may be employed to measure the relationship between the inference of imminent use of the device and one or more independent variables, which may be obtained by the one or more sensors as well as reference motions and behaviors previously obtained. By using probability scores as the predicted values, the inference of imminent use of the device may be determined. In some implementations, when determined, the inference of imminent use may be high, corresponding to a high probability of imminent use. Alternatively, the inference of imminent use may be low, corresponding to a low probability of imminent use. As explained further below, in other implementations, the inference of imminent use can be a yes-or-no result.

In some embodiments, logistic regression can be binomial, where the binomial logistic regression may be configured to handle situations where two possible outcomes may be expected, such as treating the inference of imminent use of the device as the outcome of a Bernoulli trial. In some other embodiments, logistic regression can be multinomial, where the multinomial logistic regression may be configured to handle situations where multiple outcomes may be expected. Logistic regression may be used to predict the probability of a particular outcome using the values of the sensor measurements (e.g., values of the predictor variables), which in turn may be translated into a probability value for the inference of imminent use of the device. In some applications, all that may be needed is the inference of imminent use of a device that simply represents a probability of imminent use of the device. In other applications, the inference of imminent use of the device may be a specific yes-or-no prediction regarding the imminent use of the device. This categorical prediction can be based on the probability of a prediction, with the predicted probability being compared to certain threshold value; and the outcome of the comparison may be translated into an inference of imminent use of the device.

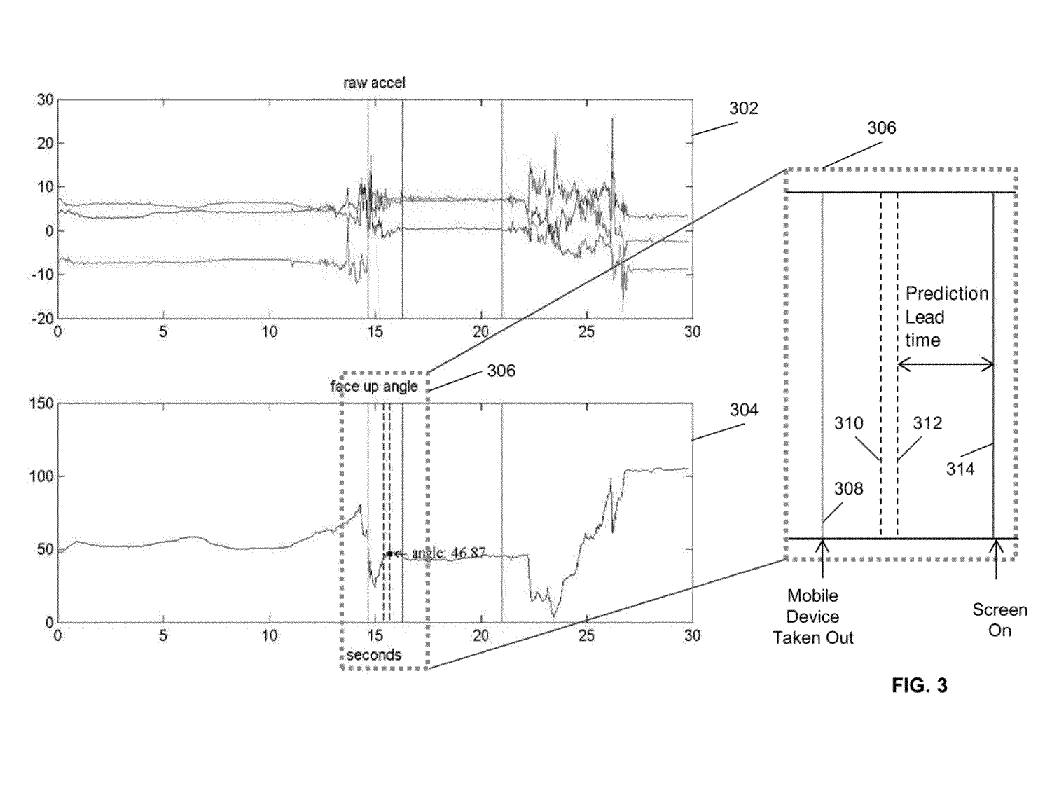

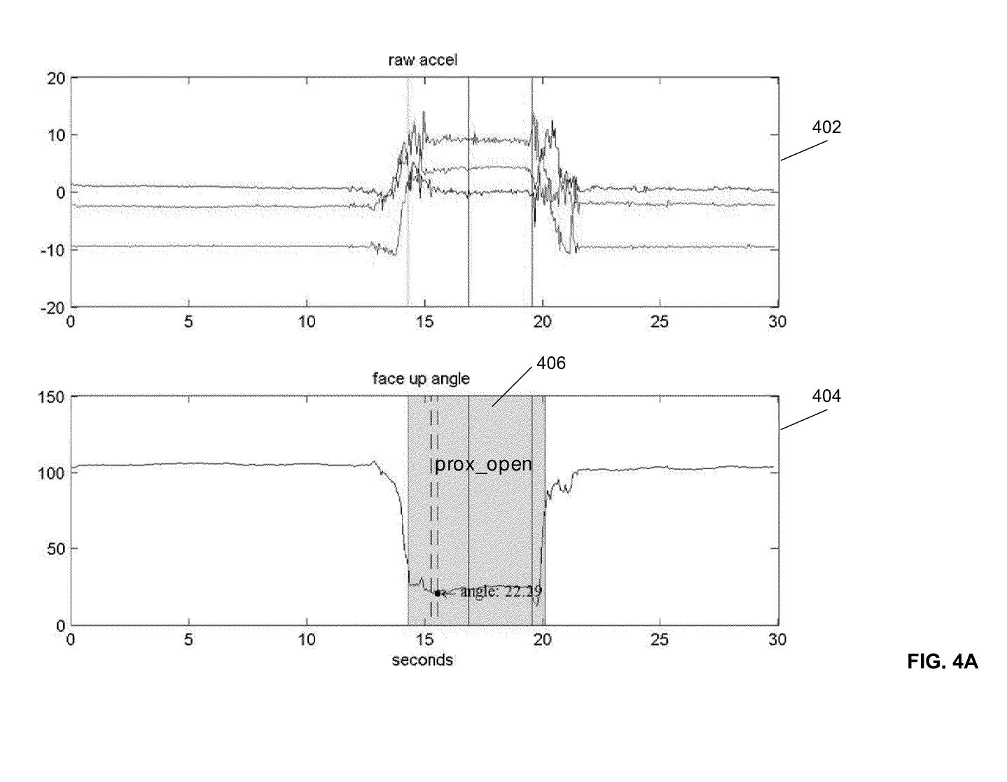

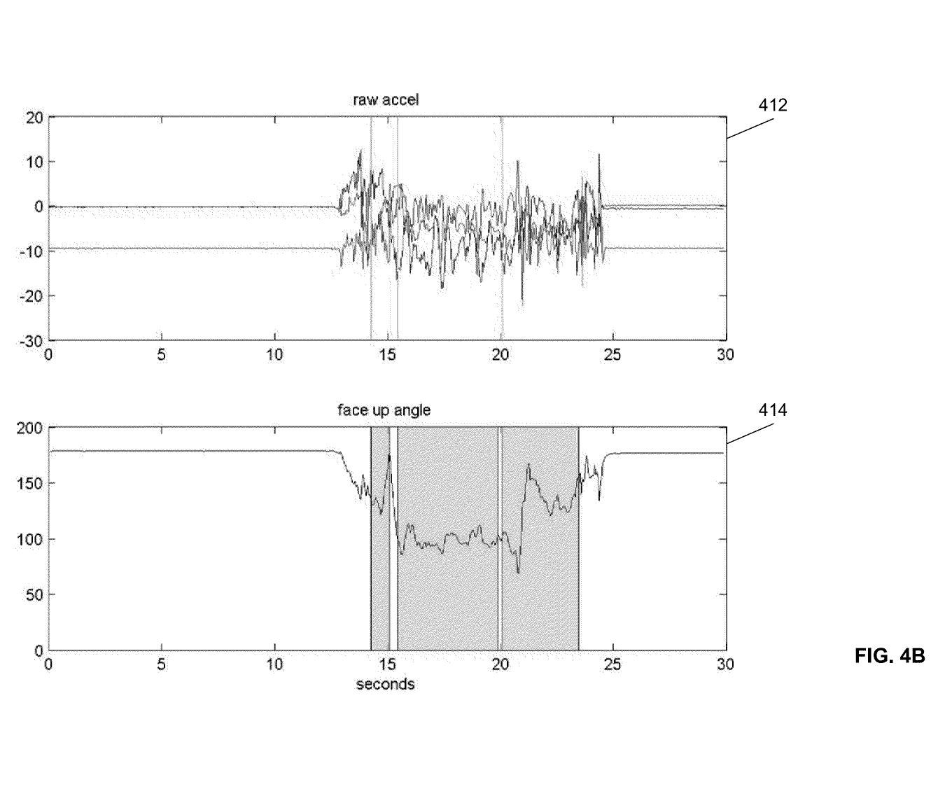

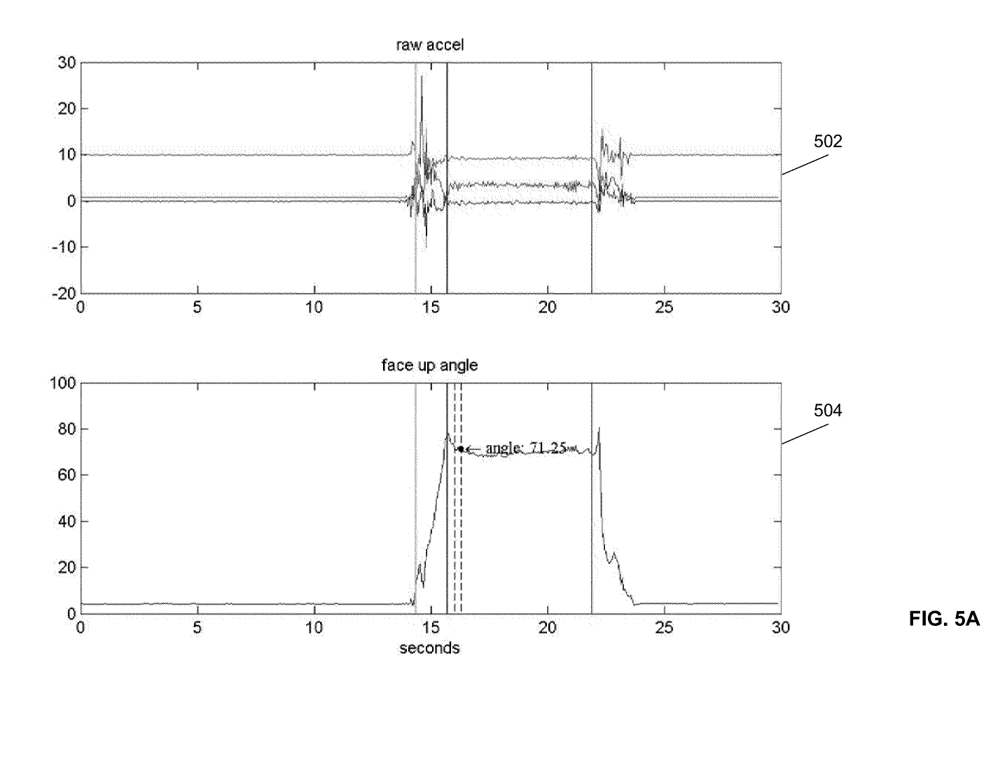

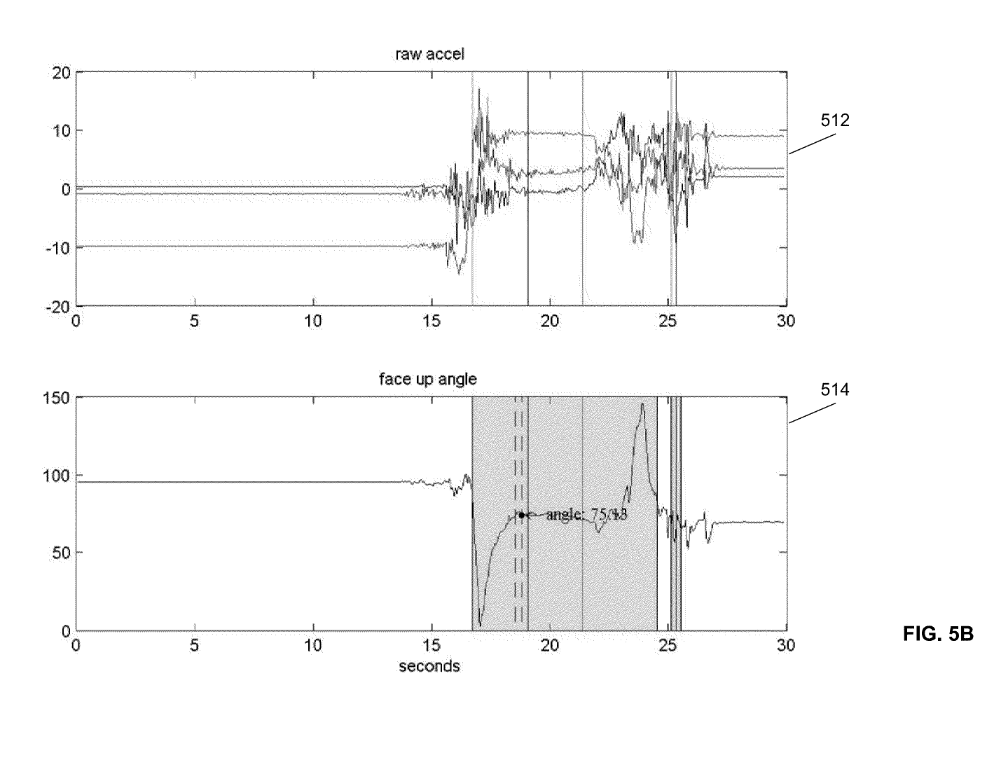

According to aspects of the present disclosure, successful pick-up detection of a mobile device may trigger operations of face position detection. To perform face position detection, one exemplary approach is to check whether the angle subtended by the gravity vector relative to an axis (for example the z-axis) of the mobile device has stabilized in a range indicative of face position. In this exemplary approach, a sliding window may be selected, which may have a time period of 0.3 second and which may stop at 5 seconds after a proximity sensor has been closed, as indicated by one or more proximity sensors. A face-up angle may be considered to be stabilized if the angle does not change substantially within the given window. One way to determine the angle does not change substantially within the given window is to compute a difference between a maximum of face-up angles in the window and a minimum of face-up angles in the window. If the difference is less than a predetermined threshold, then the face-up angle may be deemed to be stabilized. This approach may be employed in face position detection as described in association with FIG. 3, FIGS. 4A-4B and FIGS. 5A-5B in the following sections.

FIG. 3 illustrates an exemplary method of detecting face position of a mobile device according to some aspects of the present disclosure. As shown in FIG. 3, at approximately before the 15 second point, a mobile device may be detected to be taken out from a pant pocket. Window 302 may show exemplary measurements of one or more accelerometers over time; window 304 may show exemplary measurements of one or more ambient light sensors over time. Time segment 306 (bracketed in dotted rectangle) is enlarged on the right hand side of FIG. 3. Using the methods of pick-up detection described above in association with FIG. 1 and FIGS. 2A-2D, the mobile device can be configured to determine a time the mobile device has been taken out as indicated by line 308. In some implementations, the mobile device may be further configured to determine a time period where a proximity open detector may be triggered, indicated by dotted timeline 310 and timeline 312.

Using sensor data from windows 302 and 304, the mobile device may be configured to perform angle stabilization detection. In this example the angle may be approximately 46.87 degrees. In addition, using sensor data from windows 302 and 304, the mobile device can be configured to perform face position detection, and the results from the face position detection can be used to determine an inference of imminent use of the mobile device. With successful face position detection, the mobile device may be further configured to determine an inference of imminent use of the mobile device, and predict a lead time when the screen may be turned on. The predicted lead time may be indicated by the time period between timeline 312 and timeline 314. At timeline 314, the screen of the mobile device may be determined to be on.

FIG. 4A illustrates a group of exemplary sensor observations for angle stabilization detection of a mobile device according to some aspects of the present disclosure. Window 402 may show exemplary measurements of one or more accelerometers over time; window 404 may show exemplary measurements of one or more ambient light sensors over time. A time period 406 (shaded in gray) may indicate a period where a proximity open detector may be triggered. Using sensor data from windows 402 and 404, the mobile device may be configured to perform angle stabilization detection with z-axis. This particular embodiment may show an application scenario that a user may be sitting, and the mobile device may be in a shirt pocket. Then the mobile device may be transitioned from the shirt pocket to being held at a low angle. In this example the angle may be approximately 22.29 degrees.

FIG. 4B illustrates another group of exemplary sensor observations for angle stabilization detection of a mobile device according to some aspects of the present disclosure. Window 412 may show exemplary measurements of one or more accelerometers over time; window 414 may show exemplary measurements of one or more ambient light sensors over time. Using sensor data from windows 412 and 414, the mobile device may be configured to perform angle stabilization detection with 3 axes (e.g., x, y, and z axes) as well as face position detection. This particular embodiment may show an application scenario that a user may be sitting, and the mobile device may be in a purse. Then the mobile device may be transitioned from the purse to being held face down and the user may be walking away. The results obtained may in turn be used to determine an inference of imminent use of the mobile device.

FIG. 5A illustrates an exemplary embodiment of three axes angle stabilization of a mobile device according to some aspects of the present disclosure. In the exemplary embodiment shown in FIG. 5A, window 502 may show exemplary measurements of one or more accelerometers over time; window 504 may show exemplary measurements of one or more ambient light sensors over time. Using measurements in windows 502 and 504, the mobile device may be configured to perform angle stabilization detection with three axes (e.g., x, y, and z axes) as well as face position detection. This particular embodiment may show an application scenario that a user may be sitting, and the mobile device may be on a desk. Then the mobile device may be transitioned from the desk to be held with a tilted face-up, at a high pick-up position, for example near the ear of the user. The results obtained may in turn be used to determine an inference of imminent use of the mobile device.

FIG. 5B illustrates another exemplary embodiment of three axes angle stabilization of a mobile device according to some aspects of the present disclosure. In the exemplary embodiment shown in FIG. 5B, window 512 may show exemplary measurements of one or more accelerometers over time; window 514 may show exemplary measurements of one or more ambient light sensors over time. Using measurements in windows 512 and 514, the mobile device may be configured to perform angle stabilization detection with three axes (e.g., x, y, and z axes) as well as face position detection. This particular embodiment may show an application scenario that a user may be sitting, and the mobile device may be in a backpack. Then the mobile device may be transitioned from the backpack to be held not in a face-up position where the user is viewing the display, but at a high pick-up position, for example, near the user's ear while the user speaks during a telephone call. The results obtained may in turn be used to determine an inference of imminent use of the mobile device.

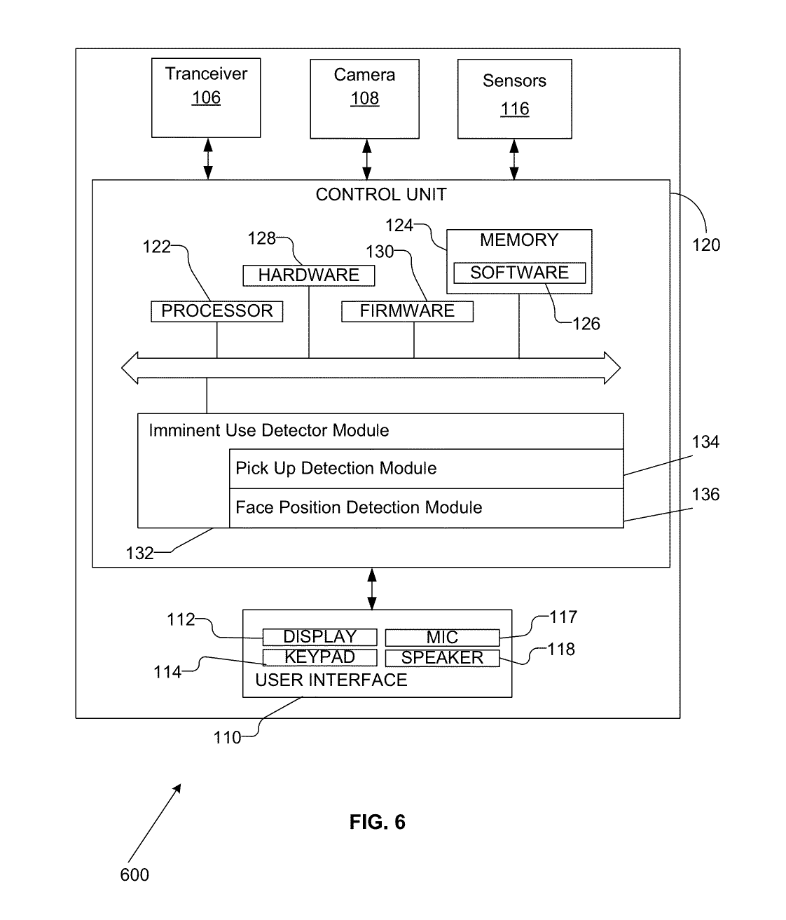

FIG. 6 illustrates an exemplary block diagram of a mobile device according to some aspects of the present disclosure. In one exemplary implementation, mobile device 600 includes a transceiver 106 configured to communicate with other computing devices including but not limited to servers and other mobile devices, a camera 108 configured to function as an image sensor to generate images, which may be either individual photos or frames of video. The mobile device 600 may also include sensors 116, which may be used to provide sensor data with which the mobile device 600 can determine inferences of imminent use. Examples of sensors that may be used with the mobile device 600, include but are not limited to, accelerometers, ambient light sensors, proximity sensors, quartz sensors, gyroscopes, micro-electromechanical system (MEMS) sensors used as linear accelerometers, as well as magnetometers.

The mobile device 600 may also include a user interface 110 that includes display 112 for displaying images. The user interface 110 may also include a keypad 114 or other input device through which the user can input information into the mobile device 600. If desired, the keypad 114 may be obviated by integrating a virtual keypad into the display 112 with a touch sensor. The user interface 110 may also include a microphone 117 and one or more speakers 118, for example, if the mobile platform is a cellular telephone. Of course, mobile device 600 may include other components unrelated to the present disclosure.

The mobile device 600 further includes a control unit 120 that is connected to and communicates with transceiver 106, camera 108 and sensors 116, as well as user interface 110, along with any other desired features. The control unit 120 (also referred to as controller) may be provided by one or more processors 122 and associated memory/storage 124. The control unit 120 may also include software 126, as well as hardware 128, and firmware 130. The control unit 120 may include imminent use detector module 132 configured to detect inferences of imminent use of the mobile device 600. The imminent use detector module 132 may further include pick up detection module 134 configured to determine whether mobile device 600 has been picked up, and face position detection module 136 configured to determine face position of mobile device 600 after it has been picked up.

The imminent use detector module 132 is illustrated separately from processor 122 and/or hardware 128 for clarity, but may be combined and/or implemented in the processor 122 and/or hardware 128 based on instructions in the software 126 and the firmware 130. Note that control unit 120 can be configured to implement methods of imminent use detection. For example, the control unit 120 can be configured to implement functions of the mobile device 600 described in FIGS. 1-5 and FIGS. 7-8.

The disclosed methods and apparatuses can be applied to enable power savings in mobile devices, and simultaneously deliver better user experience with an “always-on”, low-power inference engine on the mobile device that can accurately predict its imminent use in the next few seconds, for example between 1 and 60 second. According to aspects of the present disclosure, as long as the device has power and is operating under an intended operating condition, the imminent use detector may be configured to be “always-on” to receive sensor data, for example from an accelerometer. And the imminent use detector may be configured to perform the functions as described herein continuously.

According to aspects of the present disclosure, an imminent use detector can be configured to consume accelerometer data, along with other pieces of information made available from low power sources on the mobile device (e.g., grip sensors, time of the day, day of the week, ambient light sensor, etc.) to produce the desired inference of imminent use. In addition, information relating to incoming and outgoing phone calls and text messages, various notification methods (e.g., ringer, flashing LED, etc.), charging status, and information from Bluetooth scans may also be used to produce the desired inference of imminent use. In some implementations, the imminent use detector can be configured to reside as part of a low-power sensors subsystem.

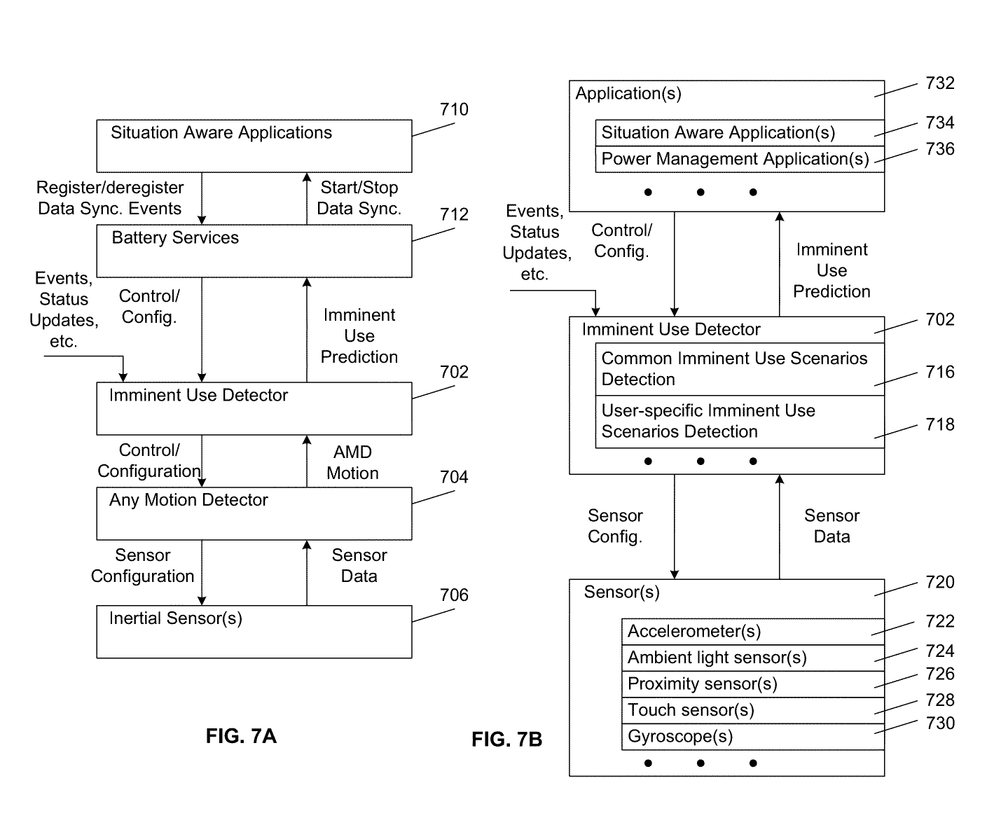

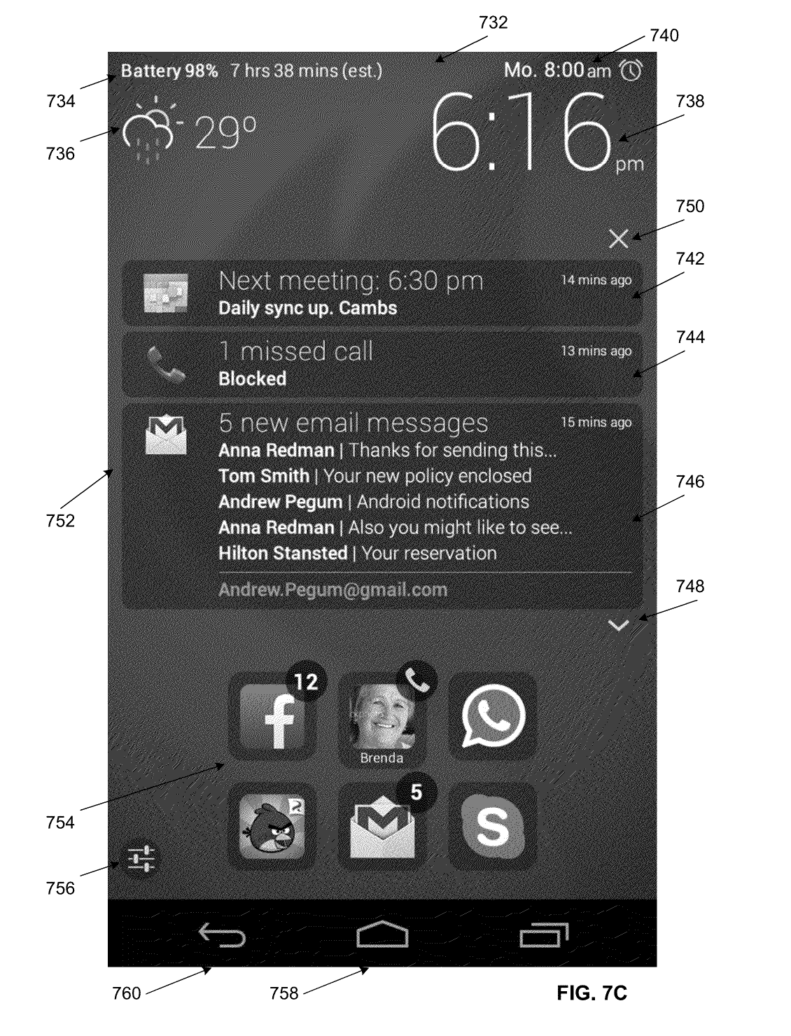

FIG. 7A illustrates an exemplary application environment of an imminent use detector according to some aspects of the present disclosure. In an exemplary embodiment, an imminent use detector 702 may be configured to send control and/or configuration information to an Any-motion detector (AMD) 704. Using the control and/or configuration information, the any-motion detector 704 may be configured to set the configurations of inertial sensor(s) 706. The inertial sensor(s) 706 may then collect and send sensor data to the Any-motion detector 704, which in turn generates an AMD motion indicator to the imminent use detector 702.

According to aspects of the present disclosure, situation aware applications 710 may be configured to send register/deregister and data synchronization events to battery services (application/module) 712. Using the register/deregister and data synchronization events, the battery services 712 may be configured to send control and/or configuration information to the imminent use detector 702, which may be used to configure the imminent use detector 702, the any motion detector 704 and the inertial sensor(s) 706. In addition, the imminent use detector 702 may be configured to receive information, such as events, status updates, and other relevant information. The imminent use detector 702 may then use the received information, including sensor information from the AMD 704, control and/or configuration information from battery services 712, events and status updates to predict an inference of imminent use, which may also be referred to as an imminent use prediction. Upon predicting the inference of imminent use, the imminent use detector 702 may send this information to configure the battery services 712 for controlling the power to be consumed by the mobile device. The battery services 712 may then use the imminent use prediction to inform the situation aware applications 710 to start/stop data synchronization, in some exemplary applications. The functions of the imminent use detector 702, AMD 704, inertial sensor(s) 706, situation aware applications 710, and battery services 712 may be performed by various blocks of the mobile device 600 as described in association with FIG. 6.

FIG. 7B illustrates another exemplary application environment of an imminent use detector according to some aspects of the present disclosure. In the exemplary implementation shown in FIG. 7B, imminent use detector 702 may be configured to communicate with one or more sensor(s) 720 and one or more application(s) 732.

The imminent use detector 702 may include logic configured to perform common imminent use scenarios detection 716 as well as logic configured to perform user-specific imminent use scenarios detection 718. According to aspects of the present disclosure, an event that may influence the prediction of an inference of imminent use of a device may comprise two components. The first component can be a supervised component that may be trained to recognize some universal gestures/scenarios associated with an act of actively using the device (e.g. a phone), such as pulling the device out of a pocket, picking up the device off a table/desk, or the ringing/vibrating that typically results in the user picking up the device. The second component may be a user-specific component, wherein imminent phone usage traits specific to the device's owner (or, the most frequent user) can be used to fine-tune the above supervised component. For instance, if the user is left-handed, such details may be collected from the user in a one-time fashion during registration, or be detected on-the-fly. In other situations, for example, a user may almost always ignore calls from certain phone numbers, in which case, it may be likely that there would not be an imminent usage of the device even though the device may be ringing.

In the example shown in FIG. 7B, the one or more sensor(s) 720 may include, but not limited to, one or more accelerometer(s) 722, one or more ambient light sensor(s) 724, one or more proximity sensor(s) 726, one or more touch sensor(s) 728, one or more gyroscope(s) 730, etc. The one or more application(s) 732 may include, but not limited to, one or more situation aware application(s) 734, one or more power management application(s) 736, etc. The functions of the imminent use detector 702, one or more sensor(s) 720, and one or more application(s) 732 may be performed by various blocks of the mobile device 600 as described in association with FIG. 6.

According to aspects of the present disclosure, the one or more application(s) 732 may be configured to send control and/or configuration information to the imminent use detector 702. Using the control and/or configuration information, as well as events, status updates, and other relevant information received, the imminent use detector 702 may be configured to generate and send sensor configuration information to the one or more sensor(s) 720. In addition, the imminent use detector 702 may be configured to determine inferences of imminent use, also referred to as imminent use prediction(s), from sensor data received from the one or more sensor(s) 720. The imminent use prediction(s) may be used to assist the situation aware applications(s) 734 as well as the power management application(s) 736, in some exemplary implementations.

For example, the inference of imminent use may be applied to assist intelligent data synchronization. Applications (e.g., email, Facebook, Twitter, Photos) typically send periodic data synchronization requests in the background regardless of whether the user is going to check for this new data in the near future. Data synchronizations can be costly, so it is desirable to limit such data synchronization only when they are really needed. In some implementations, applications may subscribe to the determination of inference of imminent use from a low-power engine, and send data synchronization requests only when this low-power engine signals imminent device use.

In another implementation, the imminent use detector trigger can be used in place of a screen-on trigger. For example, some applications may turn off Wi-Fi in power-crunched scenarios and may attempt connecting to an available access point upon observing a “screen on” event. This may be less desirable as it can increase the latency associated with data delivery to the user, thereby degrading user experience. For example, it may not be desirable for a user to wait for a “spinning wheel”, or wait for the data loading icon for a number of seconds. Using the imminent use detector trigger, such waiting time may be reduced.

FIG. 7C illustrates an exemplary application upon a determination of an inference of imminent use of a device according to some aspects of the present disclosure. Based on the inference of imminent use, the mobile screen may be turned on automatically without waiting for the user to press the on/off button, and the mobile screen may be configured to present relevant information to the user. This can be a desirable user interface feature implemented in a lock screen widget. Using this user interface feature, the user may be able to take a glance of the mobile screen and be informed of status information, notifications of communication activities, and predicted applications to be used, which the user has previously programmed the lock screen widget to display. In the example shown in FIG. 7C, the mobile screen 732 may be configured to display information, including but not limited to: 1) percentage of battery life and a predicted battery life of the mobile device in terms of hours and minutes 734; 2) weather conditions at current location 736; 3) current time 738; 4) next alarm time 740.

According to aspects of the present disclosure, the mobile screen 732 may be configured to display notifications in chronological order with the number of minutes since arrival. The notifications may include, but not limited to: 1) next calendar appointment within the next two hours 742; 2) one or more missed calls 744; and one or more email messages 746. In one particular implementation, the user may use the down arrow 748 to access additional notifications; may tap on a notification to open the notification in the corresponding application (e.g. calendar, phone, or email); may dismiss an individual notification by swiping the corresponding lozenge; and may dismiss all notifications using the delete symbol (shown as “X”) 750. The notifications may be shown in semi-transparent lozenges 752. In the event when there are no notifications, the screen area covered by the semi-transparent lozenges 752 may be blank, and a message such as “you have no new notifications” may be displayed.

According to aspects of the present disclosure, the mobile screen 732 may be configured to display a number of predicted applications 754 the user may use as well as a person the user may contact via phone, text messages (SMS), email, etc. The user may tap on an application or a contact to open the application (e.g. Facebook, Skype, email, etc.) to initiate the communication. The applications may be overlaid with the number of messages pending. For example, there may be twelve Facebook messages and five Email messages pending in the example shown in FIG. 7C. According to aspects of the present disclosure, the mobile screen 732 may display a link to settings 756 to enable the user to change the settings based on the information received through a glance of the mobile screen 732. Tapping the home button 758 or back button 760 may dismiss the glance feature and transition the mobile screen 732 to display other predetermined user interface settings.

According to aspects of the present disclosure, the mobile screen may be turned off based on the inference of imminent use, for example when the inference of imminent use is low, without the user pressing the on/off button. This can be a beneficial power saving feature. For example, a user may sometimes leave the device on the desk with screen on. In such situations, the imminent use detector may be configured to determine that there may be no imminent usage of the device, and turn off the display, which may be a heavy battery draining component. In addition, the inference of imminent use may also be used to trigger other higher power always-on context use cases, such as voice-based device wake-up (e.g., user may say “Hey Snapdragon” to start interacting with mobile device) and camera-based mobile user authentication, such as face recognition algorithm to authenticate user of mobile device.

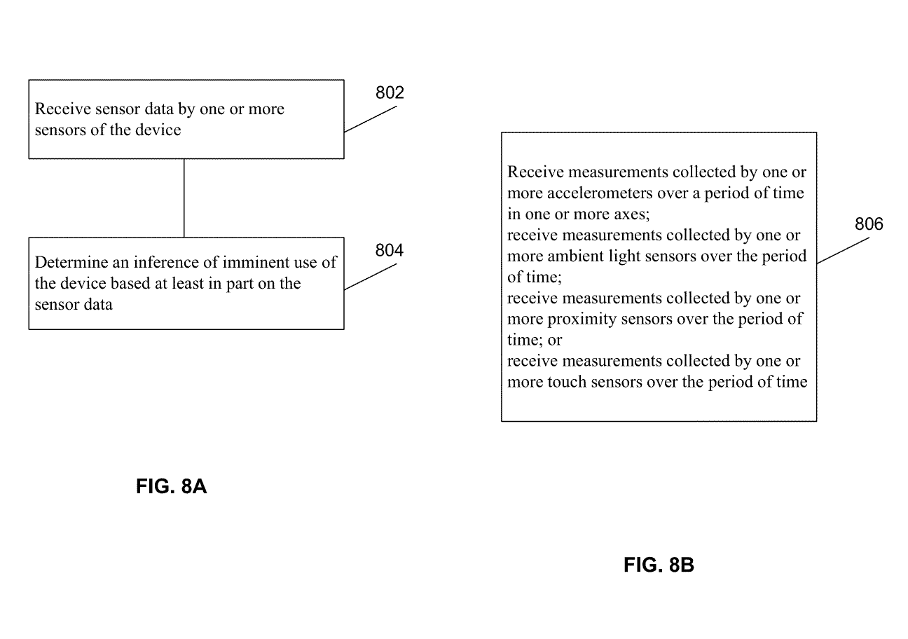

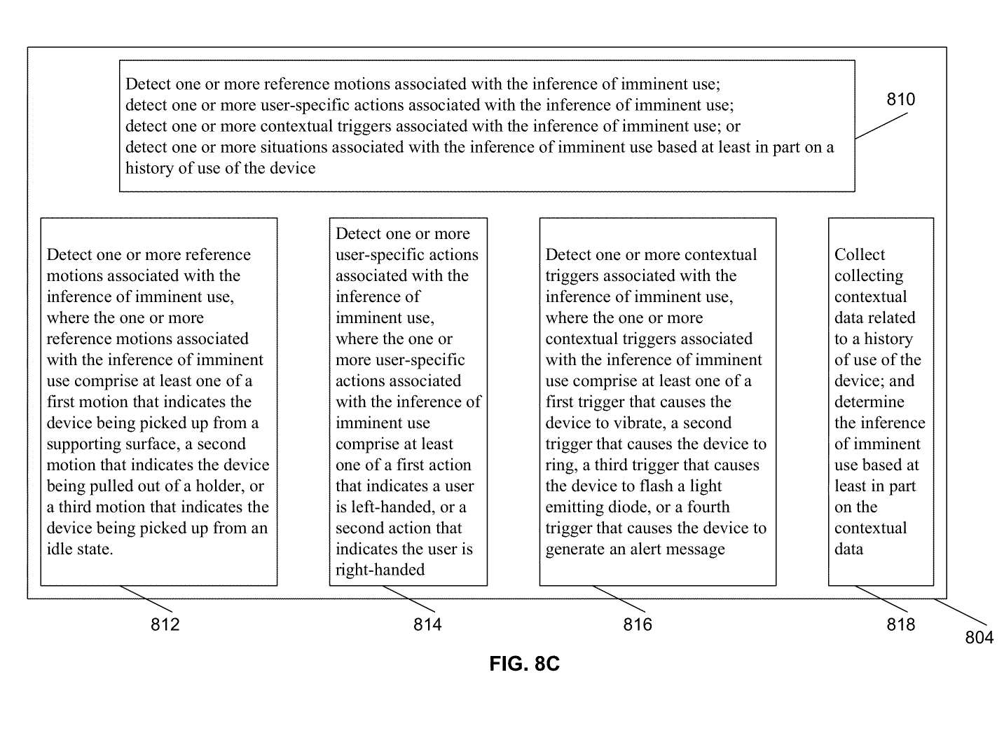

FIG. 8A illustrates an exemplary flow chart of detecting imminent use of a device according to some aspects of the present disclosure. In the exemplary implementation shown in FIG. 8A, in block 802, the method receives sensor data by one or more sensors of the device. In block 804, the method determines an inference of imminent use of the device based at least in part on the sensor data. In some implementations, the inference of imminent use may indicate the device may be used within a period of 1 to 60 second.

According to aspects of the present disclosure, the method may further perform data synchronization in accordance with the inference of imminent use, provide an application interface for one or more applications to use the inference of imminent use, or provide one or more commands to control an operation of the device based at least in part on the inference of imminent use.

According to aspects of the present disclosure, the method may further generate one or more commands to control an application in accordance with the inference of imminent use, turn on a screen in response to the inference of imminent use being above a first predetermined threshold value prior to receiving a user's command to use the device, or turn off the screen in response to the inference of imminent use being below a second predetermined threshold value prior to receiving the user's command to stop using the device

FIG. 8B illustrates an exemplary implementation of receiving sensor data of FIG. 8A according to some aspects of the present disclosure. In block 806, a method may receive measurements of acceleration of the device over a period of time in one or more axes collected by one or more accelerometers, receive measurements of ambient light detected by the device over the period of time collected by one or more ambient light sensors, receive measurements of proximity of the device to other objects over the period of time collected by one or more proximity sensors, or receive measurements of the device being touched over the period of time collected by one or more touch sensors.

FIG. 8C illustrates exemplary implementations of determining an inference of imminent use of the device of FIG. 8A according to some aspects of the present disclosure. In one embodiment, a method of determining an inference of imminent use may detect one or more reference motions associated with the inference of imminent use, detect one or more user-specific actions associated with the inference of imminent use, detect one or more contextual triggers associated with the inference of imminent use, or detect one or more situations associated with the inference of imminent use based at least in part on a history of use of the device, as shown in block 810.

In another embodiment, the method of determining an inference of imminent use may detect one or more reference motions associated with the inference of imminent use, where the one or more reference motions associated with the inference of imminent use comprise at least one of a first motion that indicates the device being picked up from a supporting surface, a second motion that indicates the device being pulled out of a holder, or a third motion that indicates the device being picked up from an idle state, as shown in block 812.

In yet another embodiment, the method of determining an inference of imminent use may detect one or more user-specific actions associated with the inference of imminent use, where the one or more user-specific actions associated with the inference of imminent use comprise at least one of a first action that indicates a user is left-handed, or a second action that indicates the user is right-handed, as shown in block 814.

In yet another embodiment, the method of determining an inference of imminent use may detect one or more contextual triggers associated with the inference of imminent use, where the one or more contextual triggers associated with the inference of imminent use comprise at least one of a first trigger that causes the device to vibrate, a second trigger that causes the device to ring, a third trigger that causes the device to flash a light emitting diode, or a fourth trigger that causes the device to generate an alert message, as shown in block 816.

In yet another embodiment, the method of determining an inference of imminent use may collect contextual data related to a history of use of the device, and determine the inference of imminent use based at least in part on the contextual data, as shown in block 818.

Note that various paragraphs herein, FIG. 1, FIG. 6, FIG. 7A-FIG. 7B, FIG. 8A-FIG. 8C and their corresponding descriptions provide means for receiving sensor data of the device; means for determining an inference of imminent use of the device based at least in part on the sensor data; means for receiving measurements collected by one or more accelerometers over a period of time in one or more axes; means for receiving measurements collected by one or more ambient light sensors over the period of time; means for receiving measurements collected by one or more proximity sensors over the period of time; means for receiving measurements collected by one or more touch sensors over the period of time; means for collecting contextual data related to a history of use of the device; and means for determining the inference of imminent use based at least in part on the contextual data.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

We claim:

1. A method of detecting imminent use of a device, comprising:
receiving sensor data by one or more sensors of the device; and
determining an inference of imminent use of the device based at least in part on the sensor data.

2. The method of claim 1, wherein the receiving sensor data comprises at least one of:
receiving measurements collected by one or more accelerometers over a period of time in one or more axes;
receiving measurements collected by one or more ambient light sensors over the period of time;
receiving measurements collected by one or more proximity sensors over the period of time; or
receiving measurements collected by one or more touch sensors over the period of time.

3. The method of claim 1, wherein the determining the inference of imminent use comprises at least one of:
detecting one or more reference motions associated with the inference of imminent use;
detecting one or more user-specific actions associated with the inference of imminent use;
detecting one or more contextual triggers associated with the inference of imminent use; or
detecting one or more situations associated with the inference of imminent use based at least in part on a history of use of the device.

4. The method of claim 1, wherein the determining the inference of imminent use comprises:
detecting one or more reference motions associated with the inference of imminent use, wherein the one or more reference motions associated with the inference of imminent use comprise at least one of a first motion that indicates the device being picked up from a supporting surface, a second motion that indicates the device being pulled out of a holder, or a third motion that indicates the device being picked up from an idle state.

5. The method of claim 1, wherein the determining the inference of imminent use comprises:
detecting one or more user-specific actions associated with the inference of imminent use, wherein the one or more user-specific actions associated with the inference of imminent use comprise at least one of a first action that indicates a user is left-handed, or a second action that indicates the user is right-handed.

6. The method of claim 1, wherein the determining the inference of imminent use comprises:
detecting one or more contextual triggers associated with the inference of imminent use, wherein the one or more contextual triggers associated with the inference of imminent use comprise at least one of a first trigger that causes the device to vibrate, a second trigger that causes the device to ring, a third trigger that causes the device to flash a light emitting diode, or a fourth trigger that causes the device to generate an alert message.

7. The method of claim 1, wherein the determining the inference of imminent use comprises:
collecting contextual data related to a history of use of the device; and
determining the inference of imminent use based at least in part on the contextual data.

8. The method of claim 1, further comprising at least one of:
generating one or more commands to control an application in accordance with the inference of imminent use;
turning on a screen in response to the inference of imminent use being above a first predetermined threshold value prior to receiving a user's command to use the device; or
turning off the screen in response to the inference of imminent use being below a second predetermined threshold value prior to receiving the user's command to stop using the device.

9. The method of claim 1 further comprising at least one of:
performing data synchronization in accordance with the inference of imminent use;
providing an application interface for one or more applications to use the inference of imminent use; or
providing one or more commands to control an operation of the device based at least in part on the inference of imminent use.

10. The method of claim 9, wherein the providing the application interface for the one or more applications comprises at least one of:
displaying one or more notifications of communication activities in response to the inference of imminent use;
displaying one or more predicted applications to be used in response to the inference of imminent use; or
displaying one or more status information of interest to a user in response to the inference of imminent use.

11. A device, comprising:
one or more sensors configured to receive sensor data of the device;
a non-transitory memory configured to store the sensor data; and
a controller comprising one or more processors and an imminent use detector, wherein the one or more processors and the imminent use detector comprise logic configured to determine an inference of imminent use of the device based at least in part on the sensor data.

12. The device of claim 11, wherein the inference of imminent use indicates the device is to be used within a period of 1 to 60 second.

13. The device of claim 11, wherein the one or more sensors comprise at least one of:
one or more accelerometers configured to collect measurements of acceleration of the device over a period of time in one or more axes;
one or more ambient light sensors configured to collect measurements of ambient light detected by the device over the period of time;
one or more proximity sensors configured to collect measurements of proximity of the device to other objects over the period of time; or
one or more touch sensors configured to collect measurements of the device being touched over the period of time.

14. The device of claim 11, wherein the logic configured to determine the inference of imminent use comprises at least one of:
logic configured to detect one or more reference motions associated with the inference of imminent use;
logic configured to detect one or more user-specific actions associated with the inference of imminent use;
logic configured to detect one or more contextual triggers associated with the inference of imminent use; or
logic configured to detect one or more situations associated with the inference of imminent use based at least in part on a history of use of the device.

15. The device of claim 11, wherein the logic configured to determine the inference of imminent use comprises:
logic configured to detect one or more reference motions associated with the inference of imminent use, wherein the one or more reference motions associated with the inference of imminent use comprise at least one of a first motion that indicates the device being picked up from a supporting surface, a second motion that indicates the device being pulled out of a holder, or a third motion that indicates the device being picked up from an idle state.

16. The device of claim 11, wherein the logic configured to determine the inference of imminent use comprises:
logic configured to detect one or more contextual triggers associated with the inference of imminent use, wherein the one or more contextual triggers associated with the inference of imminent use comprise at least one of a first trigger that causes the device to vibrate, a second trigger that causes the device to ring, a third trigger that causes the device to flash a light emitting diode, or a fourth trigger that causes the device to generate an alert message.

17. The device of claim 11, wherein the logic configured to determine the inference of imminent use comprises:
logic configured to collect contextual data related to a history of use of the device; and
logic configured to determine the inference of imminent use based at least in part on the contextual data.

18. The device of claim 11, further comprising at least one of:
logic configured to generate one or more commands to control an application in accordance with the inference of imminent use;
logic configured to turn on a screen in response to the inference of imminent use being above a first predetermined threshold value prior to receiving a user's command to use the device; or
logic configured to turn off the screen in response to the inference of imminent use being below a second predetermined threshold value prior to receiving the user's command to stop using the device.

19. The device of claim 11 further comprising at least one of:
logic configured to perform data synchronization in accordance with the inference of imminent use;
logic configured to provide an application interface for one or more applications to use the inference of imminent use; or
logic configured to provide one or more commands to control an operation of the device based at least in part on the inference of imminent use.

20. The device of claim 19, wherein the logic configured to provide the application interface for the one or more applications comprises at least one of:
logic configured to display one or more notifications of communication activities in response to the inference of imminent use;
logic configured to display one or more predicted applications to be used in response to the inference of imminent use; or
logic configured to display one or more status information of interest to a user in response to the inference of imminent use.

21. A computer program product comprises non-transitory medium storing instructions for execution by one or more computer systems, wherein the instructions comprise:
instructions for receiving sensor data by one or more sensors of a device; and
instructions for determining an inference of imminent use of the device based at least in part on the sensor data.

22. The computer program product of claim 21, wherein the instructions for receiving sensor data comprises at least one of:
instructions for receiving measurements collected by one or more accelerometers over a period of time in one or more axes;
instructions for receiving measurements collected by one or more ambient light sensors over the period of time;
instructions for receiving measurements collected by one or more proximity sensors over the period of time; or
instructions for receiving measurements collected by one or more touch sensors over the period of time.

23. The computer program product of claim 21, wherein the instructions for determining the inference of imminent use comprises:
instructions for detecting one or more reference motions associated with the inference of imminent use, wherein the one or more reference motions associated with the inference of imminent use comprise at least one of a first motion that indicates the device being picked up from a supporting surface, a second motion that indicates the device being pulled out of a holder, or a third motion that indicates the device being picked up from an idle state.

24. The computer program product of claim 21, wherein the instructions for determining the inference of imminent use comprises:
instructions for detecting one or more contextual triggers associated with the inference of imminent use, wherein the one or more contextual triggers associated with the inference of imminent use comprise at least one of a first trigger that causes the device to vibrate, a second trigger that causes the device to ring, a third trigger that causes the device to flash a light emitting diode, or a fourth trigger that causes the device to generate an alert message.

25. The computer program product of claim 21, wherein the instructions for determining the inference of imminent use comprises:
instructions for collecting contextual data related to a history of use of the device; and
instructions for determining the inference of imminent use based at least in part on the contextual data.

26. A device, comprising:
means for receiving sensor data; and
means for determining an inference of imminent use of the device based at least in part on the sensor data.

27. The device of claim 26, wherein the means for receiving sensor data of the device comprises at least one of:
means for receiving measurements collected by one or more accelerometers over a period of time in one or more axes;
means for receiving measurements collected by one or more ambient light sensors over the period of time;
means for receiving measurements collected by one or more proximity sensors over the period of time; or
means for receiving measurements collected by one or more touch sensors over the period of time.

28. The device of claim 26, wherein the means for determining the inference of imminent use comprises:
means for detecting one or more reference motions associated with the inference of imminent use, wherein the one or more reference motions associated with the inference of imminent use comprise at least one of a first motion that indicates the device being picked up from a supporting surface, a second motion that indicates the device being pulled out of a holder, or a third motion that indicates the device being picked up from an idle state.

29. The device of claim 26, wherein the means for determining the inference of imminent use comprises:
means for detecting one or more contextual triggers associated with the inference of imminent use, wherein the one or more contextual triggers associated with the inference of imminent use comprise at least one of a first trigger that causes the device to vibrate, a second trigger that causes the device to ring, a third trigger that causes the device to flash a light emitting diode, or a fourth trigger that causes the device to generate an alert message.

30. The device of claim 26, wherein the means for determining the inference of imminent use comprises:
means for collecting contextual data related to a history of use of the device; and
means for determining the inference of imminent use based at least in part on the contextual data.
